(19) United States
(12) Patent Application Publication
(10) Pub. No.: US 2011/0182629 A1
(43) Pub. Date: Jul. 28, 2011

(54) IMAGE FORMING APPARATUS AND COLOR MATCHING METHOD

(75) Inventor: Hidehito Sasaki, Tokyo (JP)

(73) Assignees: KABUSHIKI KAISHA TOSHIBA, Tokyo (JP); TOSHIBA TEC KABUSHIKI KAISHA, Tokyo (JP)

(21) Appl. No.: 13/015,056

(22) Filed: Jan. 27, 2011

Related U.S. Application Data
(60) Provisional application No. 61/299,074, filed on Jan. 28, 2010.

(51) Int. Cl. G03G 15/01

(52) U.S. Cl. 399/301

(57) ABSTRACT

According to one embodiment, an image forming apparatus includes: plural photoconductive members, a sensor, a measuring unit, a first calculating unit, a determining unit, and an adjusting unit. The sensor detects specific places of predetermined images of two colors respectively formed by two photoconductive members among the plural photoconductive members. The measuring unit measures the length between the specific places of the predetermined images detected by the sensor. The first calculating unit calculates, on the basis of the length between the specific places measured by the measuring unit, a shift amount of toner images formed by the two photoconductive members. The determining unit determines whether the shift amount calculated by the first calculating unit is within a specified range. The adjusting unit adjusts, if the determining unit determines that the shift amount is outside the specified range, shifts of toner images respectively formed by the plural photoconductive members using one of two colors as a reference color.

### CROSS-REFERENCE TO RELATED APPLICATION(S)

This application is based upon and claims the benefit of priority from: U.S. provisional application 61/299,074 filed on Jan. 28, 2010; the entire contents all of which are incorporated herein by reference.

### FIELD

Embodiments described herein relate generally to a color matching adjustment technique for an image forming apparatus.

### BACKGROUND

In the color matching adjustment technique, an amount of a shift of each of four colors yellow (Y), magenta (M), cyan (C), and black (K) is calculated from a predetermined pattern for color shift amount detection formed in each of stations respectively for the colors and adjustment and control of color matching is performed on the basis of information concerning the color shift amount.

The pattern for color shift amount detection is formed in, for example, a wedge shape. A wedge-shaped pattern for a reference color and a wedge-shaped pattern formed in another station are formed as one set. The set of the patterns is provided for each combination of the colors and three sets of the patterns are provided in total. The reference color and the other colors are compared for each of the sets to carryout detection of a shift amount of each of the colors.

However, in the case of this method, since it is necessary to image the wedge-shaped patterns for the colors, a large quantity of toners is consumed.

### DESCRIPTION OF THE DRAWINGS

FIG. 1 is a longitudinal sectional view of an image forming apparatus;

FIG. 2 is a functional block diagram of the image forming apparatus;

FIG. 3 is a diagram of patterns for color shift amount detection;

FIG. 4 is a flowchart for explaining an operation example of the image forming apparatus;

FIG. 5 is a diagram of transfer positions of the patterns for color shift amount detection;

FIG. 6 is a diagram of a calculation formula for color shift amounts; and

FIG. 7 is a diagram of patterns for color shift amount detection formed by a prerequisite technique.

### DETAILED DESCRIPTION

In general, according to one embodiment, an image forming apparatus includes: plural photoconductive members, a sensor, a measuring unit, a first calculating unit, a determining unit, and an adjusting unit. The sensor detects specific places of predetermined images of two colors respectively formed by two photoconductive members among the plural photoconductive members. The measuring unit measures the length between the specific places of the predetermined images detected by the sensor. The first calculating unit calculates, on the basis of the length between the specific places measured by the measuring unit, a shift amount of toner images formed by the two photoconductive members. The determining unit determines whether the shift amount calculated by the first calculating unit is within a specified range. The adjusting unit adjusts, if the determining unit determines that the shift amount is outside the specified range, shifts of toner images respectively formed by the plural photoconductive members using one of two colors as a reference color.

An embodiment is explained below with reference to the accompanying drawings.

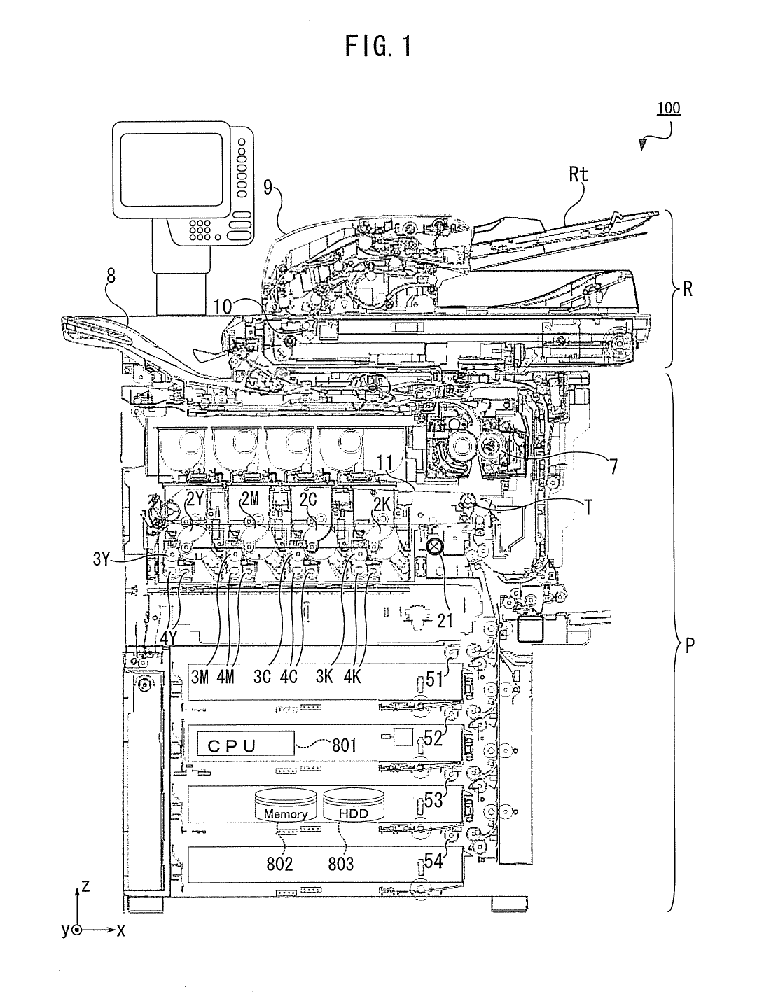

FIG. 1 is a longitudinal sectional view of a schematic configuration of an image forming apparatus (MFP: Multi Function Peripheral) according to this embodiment.

As shown in FIG. 1, an image forming apparatus 100 according to this embodiment includes an image reading unit R and an image forming unit P.

The image reading unit R has a function of scanning and reading images of a sheet document and a book document.

The image forming unit P has a function of forming a developer image on a sheet on the basis of, for example, an image read from an original document by the image reading unit R or image data transmitted from an external apparatus to the image forming apparatus 100.

The image reading unit R includes an auto document feeder (ADF) 9 that can automatically convey an original document to a predetermined image reading position. The image reading unit R reads, with a scanning optical system 10, an image of an original document automatically conveyed by the auto document feeder 9 and placed on a document tray Rt or an original document placed on a not-shown document table.

The image forming unit P includes pickup rollers 51 to 54, photoconductive members 2Y to 2K, developing rollers 3Y to 3K, mixers 4Y to 4K, an intermediate transfer belt 11, a fixing device 7, and a discharge tray 8.

Further, the image forming apparatus 100 includes a CPU (Central Processing Unit) 801, a memory 802, and a HDD (Hard disk drive) 803. The CPU 801 has a role of performing various kinds of processing in the image forming apparatus 100 and also has a role of realizing various functions by executing computer programs stored in the memory 802. The memory 802 can include, for example, a RAM (Random Access Memory), a ROM (Read Only Memory), a DRAM (Dynamic Random Access Memory), an SRAM (Static Random Access Memory), or a VRAM (Vide RAM). The memory 802 has a role of storing various kinds of information and computer programs used in the image forming apparatus 100.

The HDD 803 has stored therein data and computer programs that need to be stored in a nonvolatile manner. Functions realized using the CPU 801, the memory 802, and the HDD 803 may be realized by implementation by an ASIC (Application Specific Integrated Circuit).

As an example of processing by the image forming apparatus 100, an overview of copy processing is explained.

A sheet picked up from cassettes by the pickup rollers 51 to 54 is fed into a sheet conveying path. The sheet fed into the sheet conveying path is conveyed in a predetermined conveying direction by plural roller pairs.

Images of plural sheet documents continuously automatically conveyed by the auto document feeder 9 are read by the scanning optical system 10 in the predetermined image reading position.

Subsequently, on the basis of image data of the images read from the documents in the image reading unit R, electrostatic latent images are formed on photoconductive surfaces of the photoconductive members 2Y, 2M, 2C, and 2K for transferring developer images of yellow (Y), magenta (N), cyan (C), and black (K) onto the sheet.

Developers agitated by the mixers 4Y to 4K in the image forming unit P are supplied to the photoconductive members 2Y to 2K, on which the electrostatic latent images are formed as explained above, by the developing rollers (so-called mag rollers) 3Y to 3K. Consequently, the electrostatic latent images formed on the photoconductive surfaces of the photoconductive members 2Y, 2M, 2C, and 2K are visualized.

Developer images formed on the photoconductive members 2Y, 2M, 2C, and 2K in this way are transferred onto a belt surface of the intermediate transfer belt 11 (so-called primary transfer). The developer images conveyed by rotation of the intermediate transfer belt 11 are transferred onto conveyed sheets in a predetermined secondary transfer position T.

The developer images transferred onto the sheets are heated and fixed on the sheet by the fixing device 7.

The sheets having the developer images heated and fixed thereon are conveyed through the conveying path by plural conveying roller pairs and sequentially discharged onto the discharge tray 8.

In the image forming apparatus 100 according to this embodiment, wedge-shaped patterns (predetermined images) for color shift amount detection are transferred onto the intermediate transfer belt 11. Alignment sensors 21 as sensors configured to detect the wedge-shaped patterns are provided on the front side and the rear side (positions different from each other in a y axis direction) of the image forming apparatus 100. The alignment sensors 21 vertically irradiate a conveying surface of the intermediate transfer belt 11 and detect whether the wedge-shaped patterns pass.

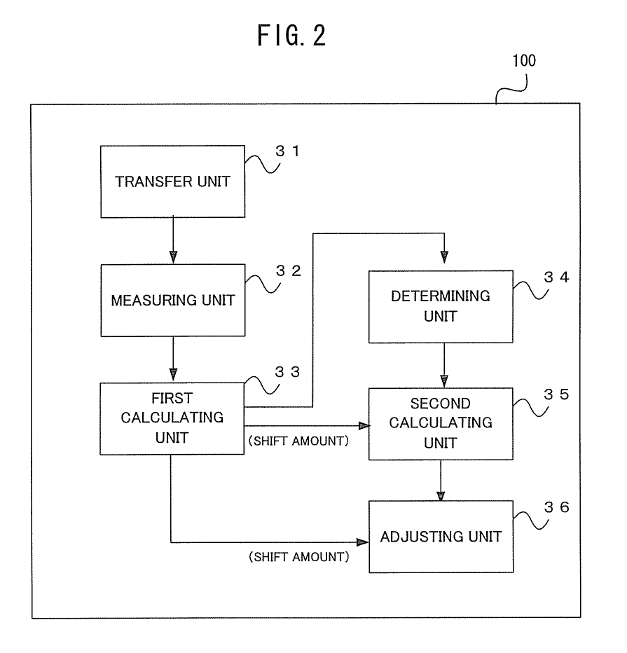

An example of functional blocks of the image forming apparatus 100 is shown in FIG. 2. The image forming apparatus 100 includes a transfer unit 31, a measuring unit 32, a first calculating unit 33, a determining unit 34, a second calculating unit 35, and an adjusting unit 36.

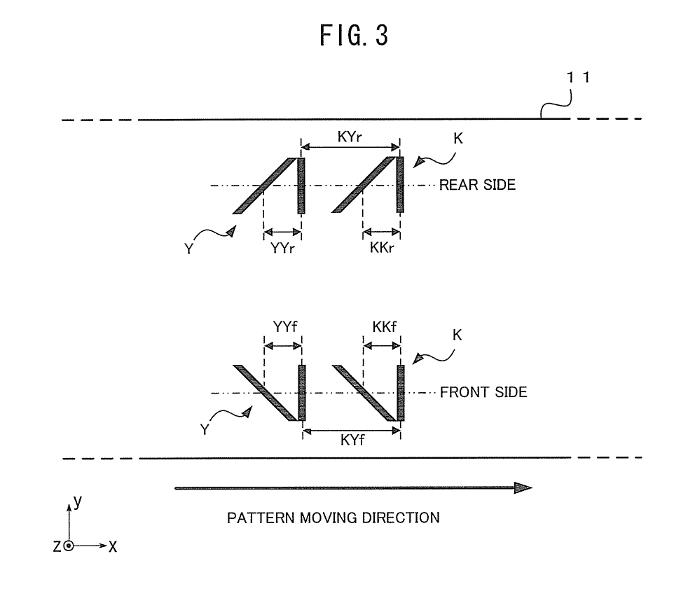

The transfer unit 31 includes the photoconductive members 2Y to 2K. The transfer unit 31 transfers the wedge-shaped patterns for color shift amount detection of at least two colors, i.e., a reference color and a representative color, onto the intermediate transfer belt 11. In this embodiment, the reference color is yellow and the representative color is black. In the following explanation, yellow is referred to as Y, cyan is referred to as C, magenta is referred to as M, and black is referred to as K. The transfer unit 31 transfers the wedge-shaped patterns respectively onto the rear side and the front side of the image forming apparatus 100. The wedge-shaped patterns are shown in FIG. 3. The wedge-shaped patterns are transferred side by side such that the wedge-shaped patterns of Y and K are respectively arranged on an upstream side and a downstream side in a moving direction of the surface of the intermediate transfer belt 11. The transfer unit 31 performs control such that the wedge-shaped patterns are transferred onto a position between sheets, i.e., an area other than an area where an image is secondarily transferred onto the sheets in the secondary transfer position T by the intermediate transfer belt 11.

The measuring unit 32 includes the alignment sensors 21. The measuring unit 32 detects the wedge-shaped patterns transferred onto the intermediate transfer belt and measures lengths (in dot unit) necessary for calculating color shift amounts. The measuring unit 32 irradiates the centers of the wedge-shaped patterns on both the rear side and the front side as shown in FIG. 3 (alternate long and two dashes lines in FIG. 3 are irradiation lines). The measuring unit 32 sets, as specific places, points where the center lines and the wedge-shaped patterns cross and measures length between the specific places (KYr, YYr, KKr, KYf, YYf, and KKf in FIG. 3). The measuring unit 32 derives the lengths between the specific places using an interval of passing times in the specific places detected by the alignment sensors 21 and moving speed of the intermediate transfer belt 11 (parameters).

The first calculating unit 33 calculates color shift amounts of the representative color with respect to the reference color using the lengths measured by the measuring unit 32. In this embodiment, the first calculating unit 33 calculates shifts amounts such as a skew shift amount, a sub-scanning position shift amount, a main scanning magnification shift amount, and a main scanning position shift amount.

The determining unit 34 acquires a specified value stored in the memory 802 in advance and determines whether the shift amounts calculated by the first calculating unit 33 are within a range of the specified value.

The second calculating unit 35 calculates shift amounts of M and C other than K if a determination result of the determining unit 34 indicates that the shift amounts are outside the range of the specified value. In this embodiment, the second calculating unit 35 multiplies shift amounts of K with a coefficient stored in the memory 802 in advance and calculates shifts amounts of M and C.

The adjusting unit 36 acquires the shift amounts of K from the first calculating unit 33, acquires the shift amounts of each of M and C from the second calculating unit 35, and performs adjustment of color shifts on the basis of the shift amounts. In this embodiment, a technique in the past is diverted to an adjustment control method by the adjusting unit 36.

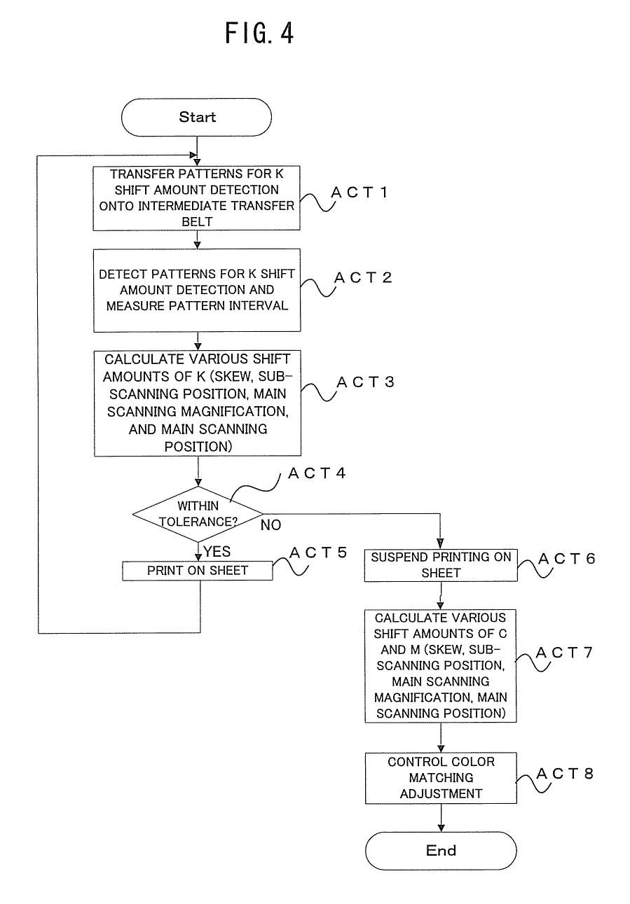

An operation example of the image forming apparatus 100 is explained below with reference to a flowchart of FIG. 4.

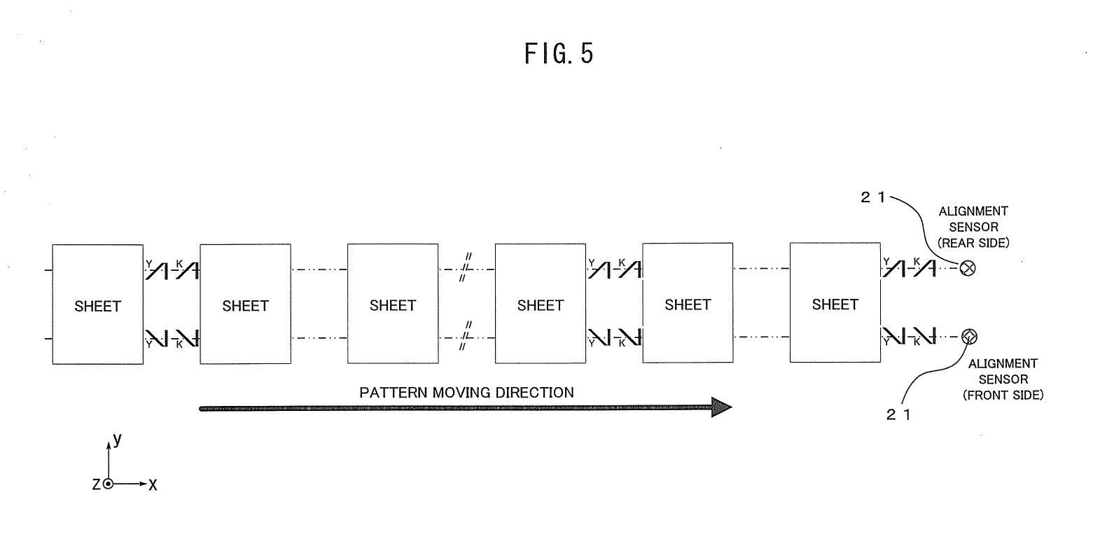

The transfer unit 31 transfers the wedge-shaped patterns with Y set as the reference color and K set as the representative color onto the intermediate transfer belt 11 (ACT 1). FIG. 5 is a diagram of transfer positions by the transfer unit 31. In FIG. 5, rectangular areas represented as “sheet” are respectively areas where images are transferred onto sheets in the secondary transfer position T. As shown in FIG. 5, the transfer unit 31 transfers the wedge-shaped patterns of Y and K onto areas among the areas where images are transferred onto sheets.

Subsequently, the measuring unit 32 detects the wedge-shaped patterns on the intermediate transfer belt 11 and measures each of the lengths shown in FIG. 3 (ACT 2).

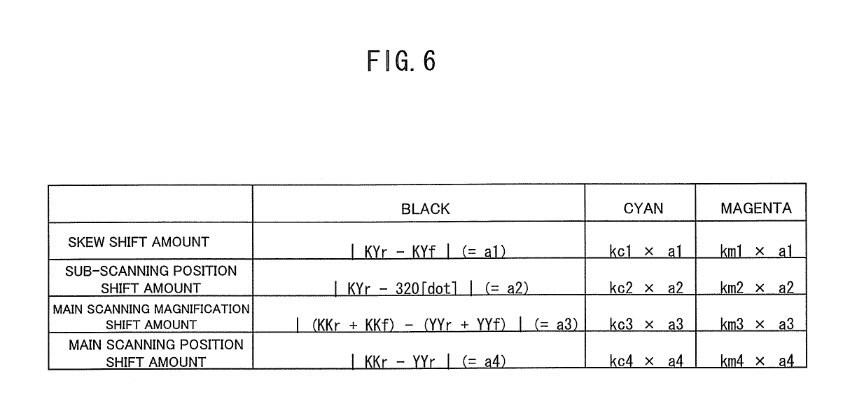

The first calculating unit 33 acquires information concerning the lengths measured by the measuring unit 32 and calculates various shift amounts of K with respect to Y (ACT 3). The first calculating unit 33 calculates the shift amounts of K using a calculation formula shown in FIG. 6 as follows:

Skew shift amount (a1) of K=|KYr−KYf|

Sub-scanning position shift amount (a2) of K=|KYr−320 (dot)|

Main scanning magnification shift amount (a3) of K=|(KKr+KKf)−(YYr+YYf)|

Main scanning position shift amount (a4) of K=|KKr−YYr|

In this embodiment, it is assumed that 320 dots is a design value of an interval between Y and K on both the rear side and the front side.

The determining unit 34 acquires specified values respectively for the shift amounts from the memory 802 and compares the shift amounts of K calculated by the first calculating unit 33 with the acquired specified values to determine whether the shift amounts are within a tolerance (ACT 4). If the shift amounts are within the tolerance (YES in ACT 4), secondary transfer processing onto a sheet is executed in the secondary transfer position T (ACT 5). Processing returns to ACT 1.

On the other hand, if the shift amounts are outside the tolerance (NO in ACT 4), the secondary transfer processing onto the sheet is suspended (ACT 6). The second calculating unit 35 calculates various shift amounts of each of C and M on the basis of the shift amounts calculated by the first calculating unit 33 (ACT 7). The second calculating unit 35 acquires coefficients Kc1 to Kc4 and Km1 to Km4 shown in FIG. 6 from the memory 802 and multiplies the shift amounts of K respectively with the coefficients to calculate shift amounts of each of C and M.

The adjusting unit 36 acquires, as parameters for control, the shift amounts of K calculated by the first calculating unit 33 and the shift amounts of each of C and M calculated by the second calculating unit 35 and performs adjustment of color matching on the basis of these values (ACT 8).

In this embodiment, the image forming apparatus 100 is an image forming apparatus employing an intermediate transfer system. The wedge-shaped patterns are transferred onto the intermediate transfer belt 11. However, the present invention can also be applied to an image forming apparatus of a direct transfer system. In the above explanation, the wedge-shaped patterns are transferred onto positions corresponding to areas among sheets. The wedge-shaped patterns may be transferred onto any area other than a secondary transfer area for sheets such as an area on the outer side of a transfer area for sheets in a direction orthogonal to the belt surface moving direction.

In the explanation of this embodiment, the reference color is Y and the representative color is K. However, this does not limit a mode of colors. Any colors may be set as the reference color and the representative color. In this embodiment, a color most hardly distorted by heat in the structure of a housing in the image forming apparatus is adopted as the reference color. A color assumed to have a largest shift amount with respect to the reference color is adopted as the representative color. Therefore, in this embodiment, a color formed by a photoconductive member arranged in a position most distant from a photoconductive member for the reference color in the moving direction of the surface of the intermediate transfer belt 11 (in this position, warp due to heat is the largest in the structure of the housing) is set as the representative color.

In some case, a color shift occurs because, for example, a supporting member for a mirror used for each of the colors is affected by heat. Therefore, a color formed by a photoconductive member corresponding to an optical element having a largest heat quantity received per unit time from a heat generating member such as a fixing device or a driving motor for a polygon mirror (an optical element closest from the heat generating member) may be set as the representative color.

When a photoconductive member is replaced by maintenance or the like of the image forming apparatus, it is most highly likely that a toner image transferred by the photoconductive member after the replacement causes a color shift. Therefore, for example, triggered by a counter value 0 of a counter indicating the number of times of transfer by the photoconductive member or according to predetermined operation by a person in charge of maintenance, the representative color may be changed to a color formed by the photoconductive member after the replacement.

In this embodiment, the second calculating unit 35 multiplies the shift amounts of the representative color with the predetermined coefficient to calculate shift amounts of the colors. However, this does not limit a mode of calculation of shift amounts. Various calculation methods are conceivable. Similarly, the calculation formula for shift amounts used by the first calculating unit 33 does not limit a mode of calculation of shift amounts. Various calculation methods are conceivable. Types of shift amounts to be calculated are not limited either.

In the explanation of this embodiment, the measuring unit 32 includes the alignment sensors 21. However, the alignment sensors 21 and a measuring unit configured to measure length between the specific places may be separately provided. In the explanation of the embodiment, at least the two alignment sensors 21 (on the rear side and the front side) are mounted. However, only one alignment sensor 21 may be provided depending on shift amounts to be calculated.

In the explanation of this embodiment, the patterns for color shift amount detection are the wedge-shaped patterns. However, this does not limit a mode of the patterns for color shift amount detection. Various shapes of the patterns for color shift amount detection are conceivable.

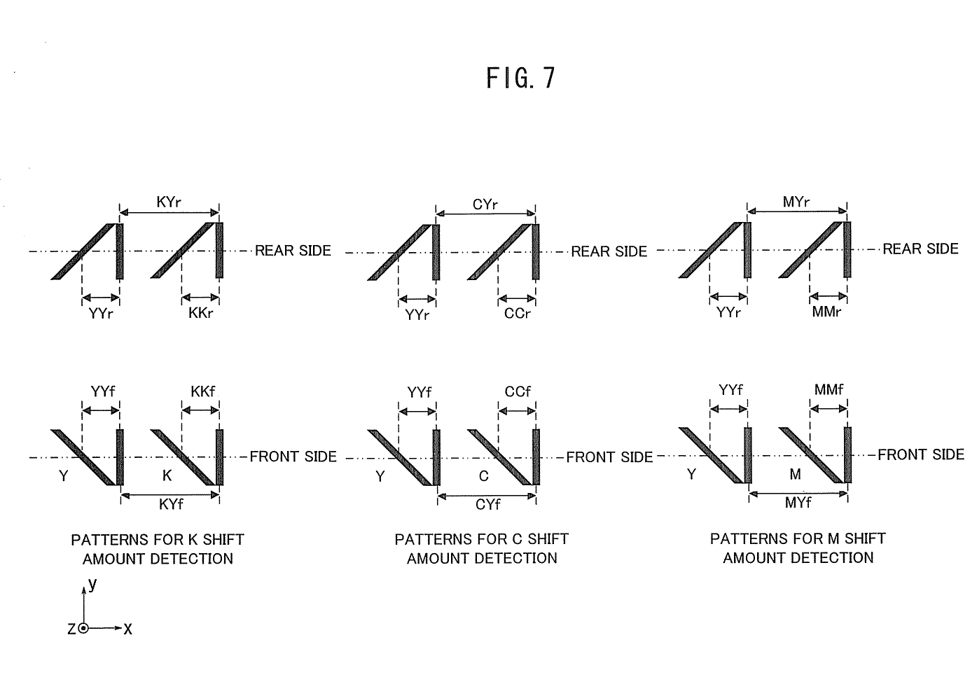

Finally, a comparison of this embodiment and a prerequisite technique of this embodiment is explained with reference to FIG. 7. In the prerequisite technique, as shown in FIG. 7, when adjustment of color matching is performed, it is necessary to form patterns for detection of all the four colors in total including the reference color and the other three colors. However, in this embodiment, as shown in FIG. 3, adjustment of color matching can be performed with only the two colors, i.e., the reference color and the representative color.

As explained above in detail, according to the technique described in this specification, it is possible to reduce an amount of use of toners when adjustment of color matching is performed.

While certain embodiments have been described, these embodiments have been presented by way of example only, and are not intended to limit the scope of invention. Indeed, the novel apparatus and methods described herein may be embodied in a variety of other forms; furthermore, various omissions, substitutions and changes in the form of the apparatus and methods described herein may be made without departing from the spirit of the inventions. The accompanying claims and their equivalents are intended to cover such forms or modifications as would fall within the scope and spirit of the inventions.

What is claimed is:

1. An image forming apparatus comprising:
plural photoconductive members;
a sensor configured to detect specific places of predetermined images of two colors respectively formed by two photoconductive members among the plural photoconductive members;
a measuring unit configured to measure length between the specific places of the predetermined images detected by the sensor;
a first calculating unit configured to calculate, on the basis of the length between the specific places measured by the measuring unit, a shift amount of toner images formed by the two photoconductive members;
a determining unit configured to determine whether the shift amount calculated by the first calculating unit is within a specified range; and
an adjusting unit configured to adjust, if the determining unit determines that the shift amount is outside the specified range, shifts of toner images respectively formed by the plural photoconductive members using one of two colors as a reference color.

2. The apparatus according to claim 1, further comprising a second calculating unit configured to calculate, from the shift amount of the toner images, which are formed by the two photoconductive members, calculated by the first calculating unit, shift amounts of toner images formed by the photoconductive members other than the two photoconductive members, wherein
the adjusting unit acquires the shift amount calculated by the first calculating unit and the shift amounts calculated by the second calculating unit and adjusts shifts of the toner images respectively formed by the plural photoconductive members.

3. The apparatus according to claim 1, wherein
the plural photoconductive members transfer the predetermined images onto a surface of an intermediate transfer belt, and
a color of the two colors that is not the reference color is a color formed by a photoconductive member most distant from a position of a photoconductive member that forms the reference color in a moving direction of the surface of the intermediate transfer belt.

4. The apparatus according to claim 1, wherein a color of the two colors that is not the reference color is a color formed by a photoconductive member corresponding to an optical element closest to a heat generating member among optical elements respectively corresponding to the plural photoconductive members.

5. The apparatus according to claim 1, wherein a color of the two colors that is not the reference color is a color formed by a photoconductive member after being replaced among the plural photoconductive members.

6. The apparatus according to claim 1, wherein the plural photoconductive members transfer the predetermined images onto a surface of an intermediate transfer belt and transfers the predetermined images onto an area on the surface of the intermediate transfer belt, which is an area other than an area onto which an image is secondarily transferred onto a sheet by the intermediate transfer belt.

7. The apparatus according to claim 1, wherein the reference color is yellow and a color of the two colors that is not the reference color is black.

8. A color matching adjustment method comprising:
an image forming apparatus detecting, using a sensor, specific places of predetermined images of two colors respectively formed by two photoconductive members among plural photoconductive members;
the image forming apparatus measuring length between the specific places of the predetermined images detected by the sensor;
the image forming apparatus calculating, on the basis of the measured length between the specific places, a shift amount of toner images formed by the two photoconductive members;
the image forming apparatus determining whether the calculated shift amount is within a specified range; and
the image forming apparatus adjusting, if it is determined that the shift amount is outside the specified range, shifts of toner images respectively formed by the plural photoconductive members using one of the two colors as a reference color.

9. The method according to claim 8, further comprising:
the image forming apparatus calculating, from the shift amount of the toner images formed by the two photoconductive members, shift amounts of toner images formed by the photoconductive members other than the two photoconductive members; and
the image forming apparatus acquiring the calculated shift amounts of the toner images and adjusting shifts of the toner images respectively formed by the plural photoconductive members.

10. The method according to claim 8, wherein
the plural photoconductive members transfer the predetermined images onto a surface of an intermediate transfer belt, and
a color of the two colors that is not the reference color is a color formed by a photoconductive member most distant from a position of a photoconductive member that forms the reference color in a moving direction of the surface of the intermediate transfer belt.

11. The method according to claim 8, wherein a color of the two colors that is not the reference color is a color formed by a photoconductive member corresponding to an optical element closest to a heat generating member among optical elements respectively corresponding to the plural photoconductive members.

12. The method according to claim 8, wherein a color of the two colors that is not the reference color is a color formed by a photoconductive member after being replaced among the plural photoconductive members.

13. The method according to claim 8, wherein the plural photoconductive members transfer the predetermined images onto a surface of an intermediate transfer belt and transfers the predetermined images onto an area on the surface of the intermediate transfer belt, which is an area other than an area onto which an image is secondarily transferred onto a sheet by the intermediate transfer belt.

14. The method according to claim 8, wherein the reference color is yellow and a color of the two colors that is not the reference color is black.
